(19) United States
(12) Patent Application Publication
(10) Pub. No.: US 2006/0201058 A1
(43) Pub. Date: Sep. 14, 2006

(54) Multipurpose growing system

(76) Inventor: Matti T. Ripatti, Janesville, CA (US)

Correspondence Address: MATTI T. RIPATTI, 465 525 ELYSIAN VALLEY RD., P.O. BOX 549, JANESVILLE, CA, 96114, US

(21) Appl. No.: 11/076,179

(22) Filed: Mar. 9, 2005

(51) Int. Cl. A01G 1/04

(52) U.S. Cl. 47/1.1

(57) ABSTRACT

A multipurpose growing system for production of commercial plants which include a unique plant carrier, which allows plants to be grown and supported without any growing media, a total flow push rod and conveyor system providing automated spacing of the plants and automated disinfecting of plant carriers and troughs. The troughs feature designs for growing either with plant carriers or without them allowing various types of crops to be grown. The troughs also feature ridges extending along the bottom to limit liquid gradients and to promote aeration of the roots. The system also consists of an nutrient controlling method for hyperaccumulating of edible crops with minerals and vitamins. Finally, the system is characterized by an automatic climate control system that features an improved design making environmental control more economical by reducing air volume subject to heating and cooling.

### BACKGROUND OF THE INVENTION

1. Field of the Invention

This invention relates in general to an improved multipurpose growing system. In particular, it is directed to system for providing automated cleaning, sterilization or pasteurization while allowing growing troughs or plant carriers to be removed and translocated mechanically or with flow of water. It is also directed to a system for providing automated increase in space for plants as they grow larger. It is also directed to a system for providing means of hyper accumulating plants with minerals and vitamins. It is also directed to a system for providing total flow with automated movement of troughs to and from growing area to service area allowing all handling to take place in a centralized location. It is also directed to a system allowing automated placing and removal of plant carriers. It is also directed to a system allowing plant carriers to be translocated with flow of water. It is also directed to a system allowing use of stopper for removal of plant carriers. It is also directed to a system allowing use of plant carriers with capillary action or absorbent base. It is also directed to a system allowing use of plant carriers without any kind of growing media. It is also directed to a system allowing rotating the shaft of push rods. It is also directed to a system allowing use of removable push rods with base. It is also directed to a system allowing use of spacing out rake.

2. Description of the Prior Art

For various reasons, the method of growing plants hydroponically has become increasingly important. Rising production costs, rising transportation costs, demand for nutritional and clean produce and environmental concerns have made hydroponic methods much more economical. The term hydroponic refers to growing of plants in absence of soil using aqueous solutions containing nutrients. Thus, the sole source of nutrients for hydroponically grown plants is the aqueous solution.

Because hydroponic operations are labor intensive, various types of equipment and methods have been devised to make the technology more economical and therefore commercially practical.

Strict environmental control equipment is needed to monitor the nutrient quality, temperature, humidity, carbon dioxide concentration, light levels geometry and spacing. Maintaining close tolerances in these parameters will result in overall lower cost as well as increasing the growth rate, yield and quality of marketable plants. An acute problem in hydroponic systems is sanitation control, since metabolic poisons can build during the plant production. In addition, salt deposits, bacteria, viruses and algae may form within the hydroponic systems.

In resolving the general problems encountered in hydroponics and perfecting those controls described above, much effort has been dedicated. Many examples of apparatus and methods directed to one or more of the foregoing problems are readily available in the literature as a result of these efforts. In fact, many hydroponic growth systems incorporating features directed specifically to the foregoing concepts are described in publications.

For example, U.S. Pat. No. 6,508,033, entitled Self Contained Fully Automated Robotic Crop Production Facility, issued to Hessel, Lior, discloses a hydroponic apparatus and method for continuous yield of fresh agricultural produce in environmentally controlled containers, which is incorporated by reference herein.

A host of additional publications include descriptions which focus on many of the foregoing and other aspects of hydroponic production systems and methods, but none combine a total greenhouse concept system which addresses total flow system with reusable plant carriers, absorbent or capillary action containing base for support of the plant without any growing media, increased trough spacing, increased plant carrier spacing, automated cleaning, disinfecting or pasteurization of plant carriers and troughs, stopper for automated removal of the plant carriers from troughs and closed loop nutrient system for hyper accumulating plants with nutrients and vitamins.

### SUMMARY OF THE INVENTION

To overcome the limitations in the prior art described above, and to overcome other limitations that will become apparent upon reading and understanding the present specification, the present invention discloses a multipurpose growing system. The present invention more particularly discloses a system for growing plants having a total flow conveyor and push rod system for transporting troughs from an entry end to a harvesting end allowing all handling to take place in a centralized location.

The present invention provides growing troughs that are removable to facilitate cleaning, disinfecting and pasteurizing. The present system facilitates easy filling of the troughs with plant carriers or containerized plants. The present system contains plant carriers with absorbent or capillary action without any need for growing media for support of a seedling or a plant. The present system contains plant carriers allowing plants to be removed with roots. The present system contains flowing liquid for transporting plant carriers from cleaning tank for placement in troughs. The present system contains a stopper for easy removal of plant carriers from troughs. The present system contains a spacing out rake for space adjustment between plant carriers or containerized plants. The present system contains support for spacing-out-rake next to the troughs. The present system contains trough movement mechanism with possibility for a stepless increase in space between troughs. The present system contains troughs with various types allowing assortment of plants to be grown.

### BRIEF DESCRIPTION OF THE DRAWINGS

FIG. 1 is an elevation view of the preferred embodiment illustrating the total flow of the plants, plant carriers and troughs.

FIG. 2 is side view of conveyor, troughs, spacing out rake and push rods with shaft.

FIG. 3 illustrates different embodiments of the plant carrier.

FIG. 4 illustrates the translocating of the plant carriers with the flow of water into the trough via the funnel shaped feeder at the end of the flow channel.

FIG. 5 illustrates removal of the plant from a plant carrier demonstrating the upward movement of the absorbent or capillary base.

FIG. 6 illustrates stopper in process of removing plant carriers from the trough and dropping them into cleaning and disinfectant tank.

FIG. 7 illustrates the different embodiments of the spacing-out-rake.

FIG. 8 illustrates the different embodiments of the push rods with base, shaft housing, pin riding in the threads of the shaft and the shaft with variable pitch threads.

### DETAILED DESCRIPTION OF THE EMBODIMENT

In following description of the preferred embodiment, reference is made to the accompanying drawings which form a part hereof, and in which is shown by way of illustration specific embodiments in which the invention may be practiced. It is also to be understood that other embodiments may be utilized and structural changes may be made without departing from the scope of the present invention.

The preferred embodiment of the present invention discloses a multipurpose growing system. The present invention provides a total flow of plant carriers and troughs from an entry end to harvest end connecting the latter to first. The total flow systems contains automated cleaning and disinfecting of the plant carriers and the troughs. By automating the hyperaccumulating of the plants with minerals and the vitamins, translocating the harvested plants to a service area, cleaning and disinfecting the plant carriers and troughs, utilizing

plant carriers without any growing media, seeding and placing the plant carriers with a flow of water into the troughs, translocating the troughs to entry end and above the push rods, translocating the troughs along support system from entry end to harvest end and utilizing stepless push rod and variable pitch shaft system in conjunction with the spacing-out-rake to increase the space the plant requires for maturing, utilization of the stopper to automatically remove the plant carriers from troughs after harvesting, removal of the plants from plant carriers with roots without damaging them a single laborer may run an entire automated growing process. Those skilled in the art will recognize that the particular embodiments of the present invention could be used with any type of hydroponic growing.

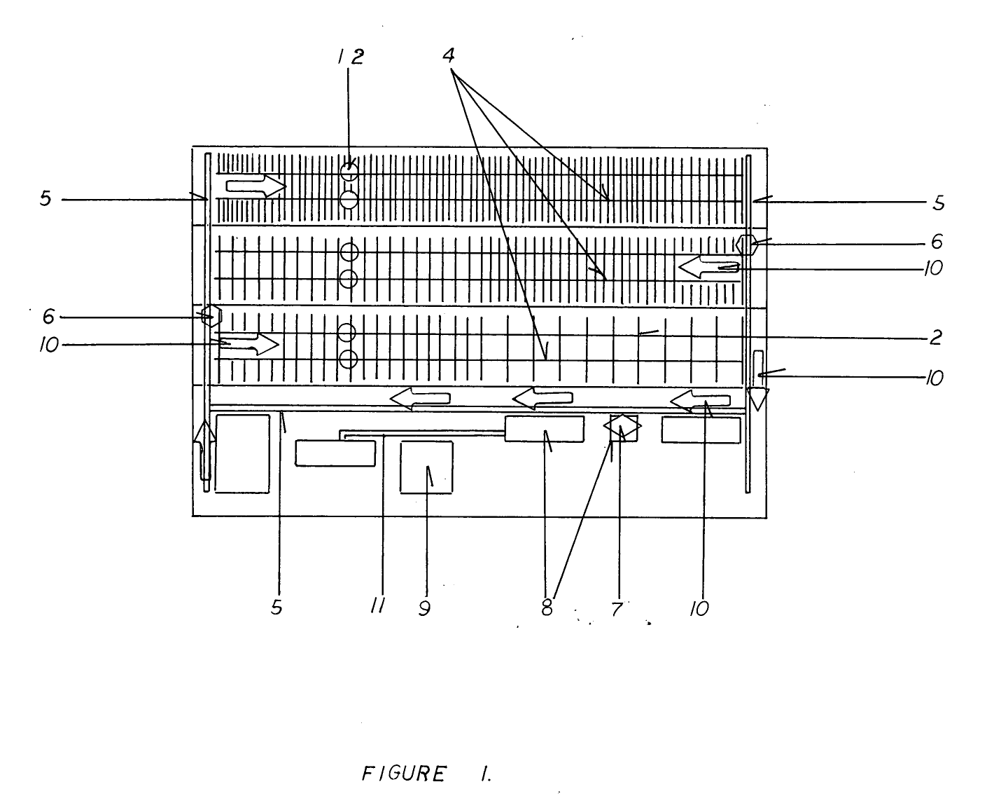

FIG. 1 illustrates an elevated view of preferred embodiment of the present invention as used in a typical hydroponic facility. The preferred embodiment includes growing troughs 2 disposed along total flow 10 conveyor 5 and push rod system 4 from entry end to harvest end. Conveyor 5 translocating troughs 2 to service area. Flow of troughs 2 by harvesting area traveling below stopper 7 for removal of empty plant carriers 1. Plant carriers 1 and troughs 2 going thru cleaning, disinfecting or pasteurization tank 8. Clean plant carriers 1 translocated to troughs 2 with flow of water 11. Conveyor 5 moving the troughs 2 with plant carriers 1 back to entry end. Location of spacing-out-rake 6 on the track traveling along conveyor 5 at the end of push rod system 3. Supports 12 for spacing-out-rake.

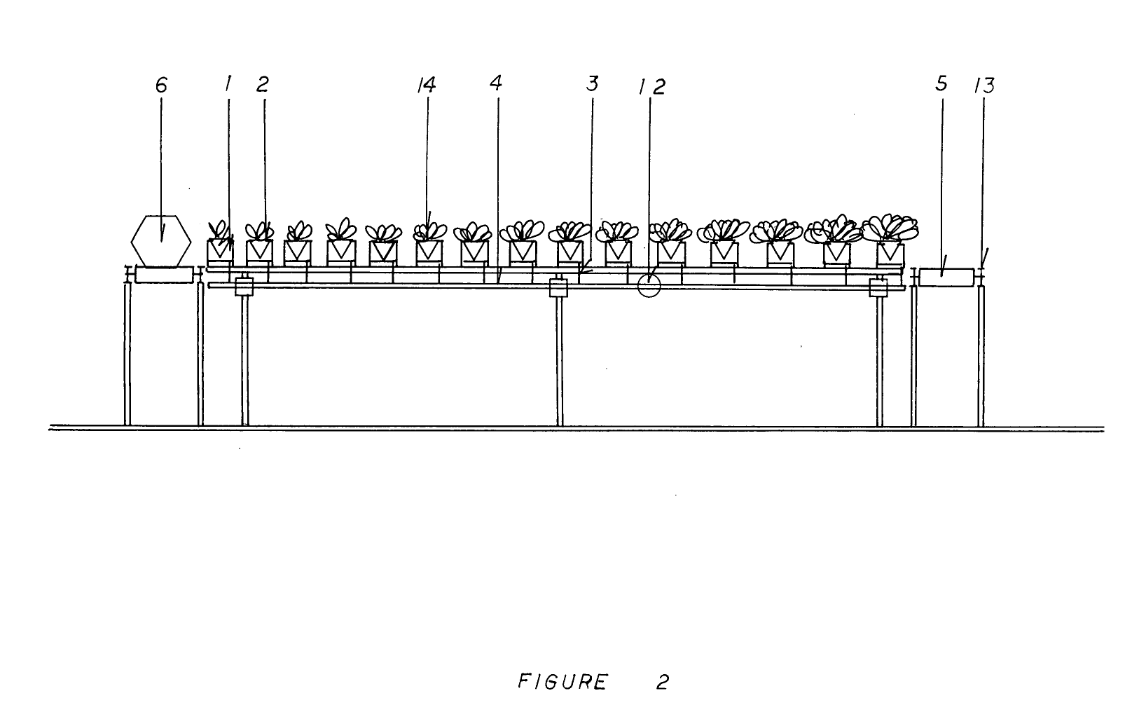

FIG. 2 is a transverse view of the multipurpose growing system. The growing troughs 2 are positioned above push rods 3 and shaft with variable pitch threads 4. Plants 14 are shown in plant carriers 1. Spacing-out-rake 6 is located on supports 13 along conveyor 5. Spacing-out-rake 5 is operated as the plants 14 require more space. The plants 14 are not removed from troughs 2, instead the spacing-out-rake 6 slides the plants 14 with the roots 18 still in the troughs 2. When needed two troughs 2 are put together end to end and plants 14 are translocated by sliding them from one trough 2 to another trough 2. Spacing-out-rake 6 will automatically set the plants 14 at desired spacing in troughs 2. Spacing-out-rake 6 travels along trough to desired location and has the arms 24 at desired spacing. The shaft 4 with rotator 12 are also shown. Push rod 3 pushes trough 2 forward from entry end towards harvest end. Trough 2 spacing increases according to the plants 14 needs as the trough 2 travels from entry end to harvest end. Push rods 3 move forward by turning the shaft with variable pitch threads 4 and thus pushing troughs 2 forward. The shaft with shaft housing 4 is rotated 90 degrees so that push rods 3 will not touch troughs and at same time turned back so that push rods 3 move back to their original position. This back and forth movement with turning of the shaft with shaft housing 4 and 27 creates the forward movement of the troughs 2.

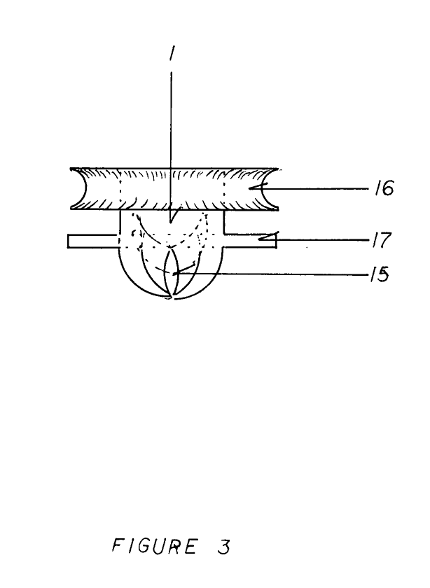

FIG. 3 illustrates the embodiment of the plant carrier 1. The capillary action or absorbent base 15 layers are on the bottom of the plant carrier 1. The layers create a support for the plant 14. They also allow the penetration of the roots 18 to the nutrient and vitamin solution. The capillary action or absorbent base 15 is built so that it allows easy removal of the plants with roots 18. The plant carrier 1 design with support wing 17 enables the plant carriers 1 to be supported and kept in place inside the trough 2. Plant carriers 1 can be spaced out along troughs 2 by spacing-out-rake 6 grippers 25 holding onto built-in gripper groove 16. Plant carriers 1 are manufactured so that they float in carrier translocator with water 11.

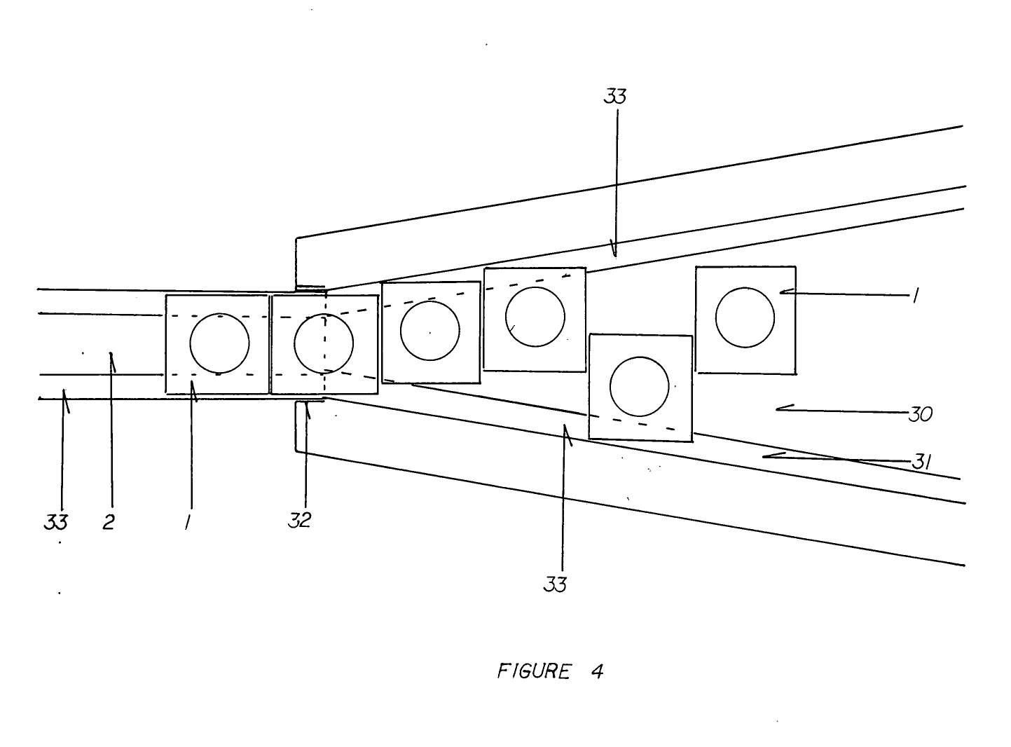

FIG. 4 illustrates the plant carriers 1 floating in feed funnel 30 into the trough 2. The end of the trough 2 is tightly sealed 32 at the mouth of the funnel 30. The level of the flowing water is controlled to facilitate the elevation of the plant carries 1. Both, the trough 2 and the funnel 32 have internal support wings 33 to house the plant carrier 1 support slot, which is located above the support wing 17. Flowing water carrying the plant carriers 1 is recirculated within the system.

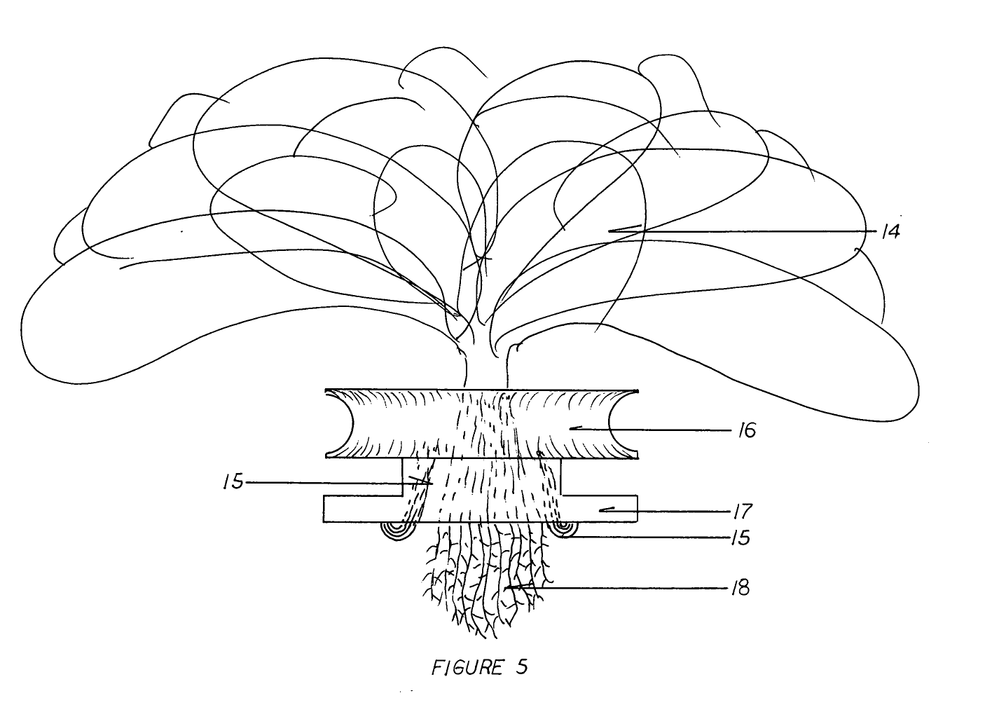

FIG. 5 illustrates the plant 24 removal from the plant carrier 1 and the absorbent or capillary action base 15 being folded up. The roots 18 of the plant 24 stay intact with the plant 24. After removal of the plant the base 15 returns back to it's original basket form.

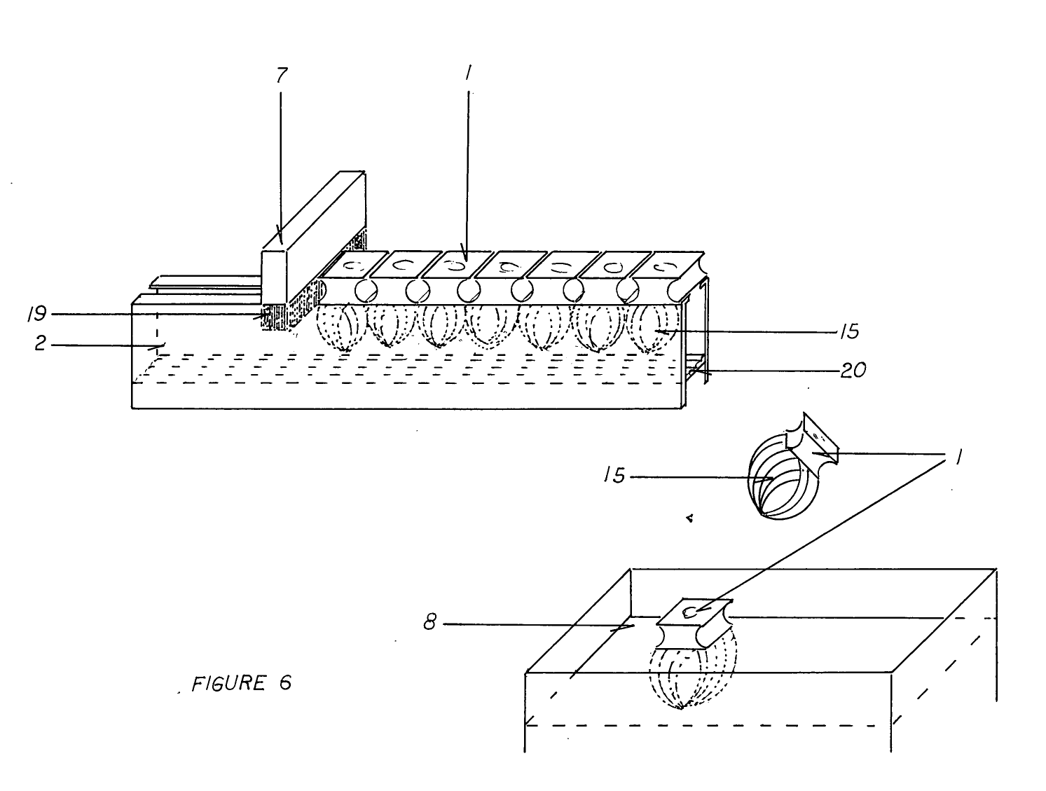

FIG. 6 illustrates the use of the stopper 7 for removal of the plant carriers 1 from the trough 2. As the trough 2 travels under the stopper 7 the plant carriers 1 are being pushed out of the trough 2 and dropped into the cleaning and disinfectant basin 8. The figure also illustrates the uneven bottom of the trough 20. The uneven bottom 20 facilitates aeration of the roots 18. The stopper has brush like stopper base 19 for cleaning the top of the trough 2 as it moves under the stopper 7.

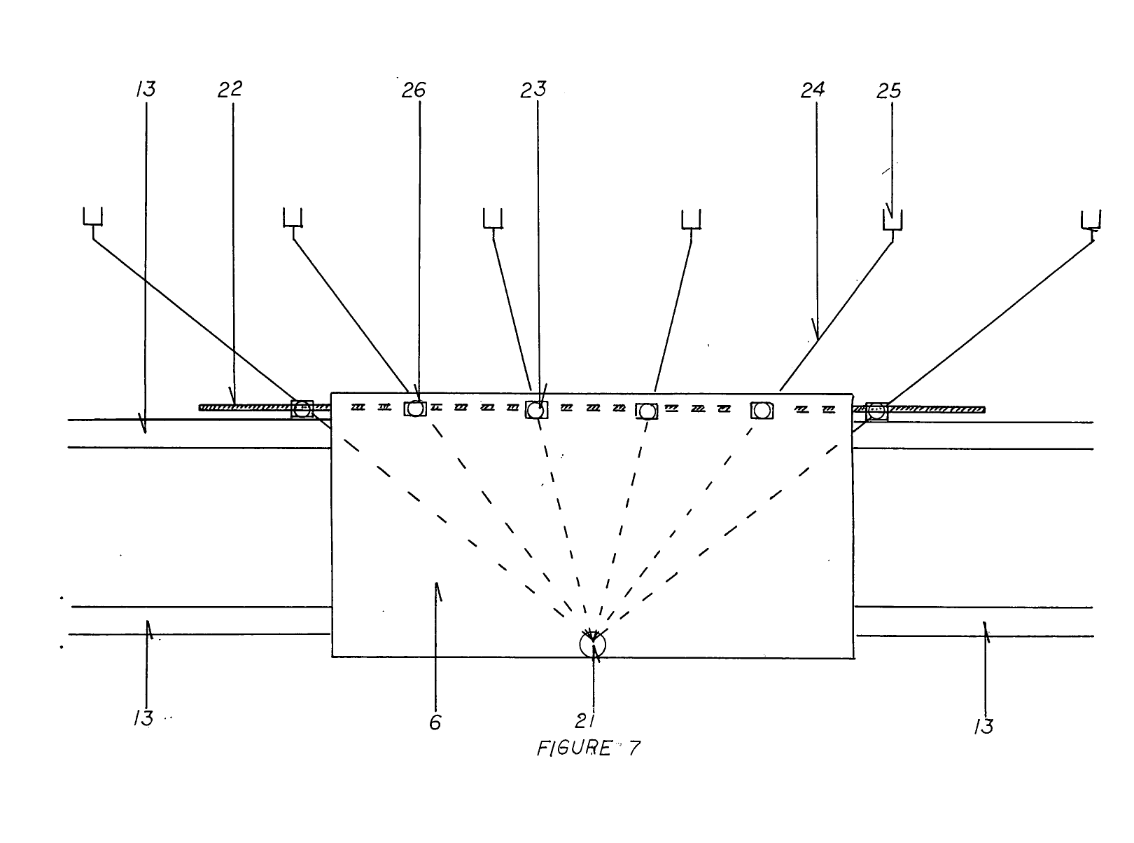

FIG. 7 illustrates the spacing-out rake 6 embodiments. The spacing-out-rake 6 travels along supports 13 which are located along the edge of the conveyor 5. The spacing between grippers 25 are adjusted according to the plants 24 growing needs by rack and pinion or by a threaded rod 22 turns. The arms 24 hold the pinions or nuts 23 which house the moving rack or rod 22. The nuts or pinions 23 are in a swivelling position to facilitate the angle changes. All the arms 24 are connected to the spacing-out-rake 6 body by a anchor 21 which allows sideways movement. The spacing-out-rake 6 slides the plants 14 which are in the plant carriers 1 along the trough 2 without lifting them out of the trough. As the plants 14 are sliding in the trough spacing-out-rake arms 24 increase the space between the plants 14. The sliding action is always against the direction of the flow of the nutrient flow thus not changing the root 18 mass direction within troughs 2.

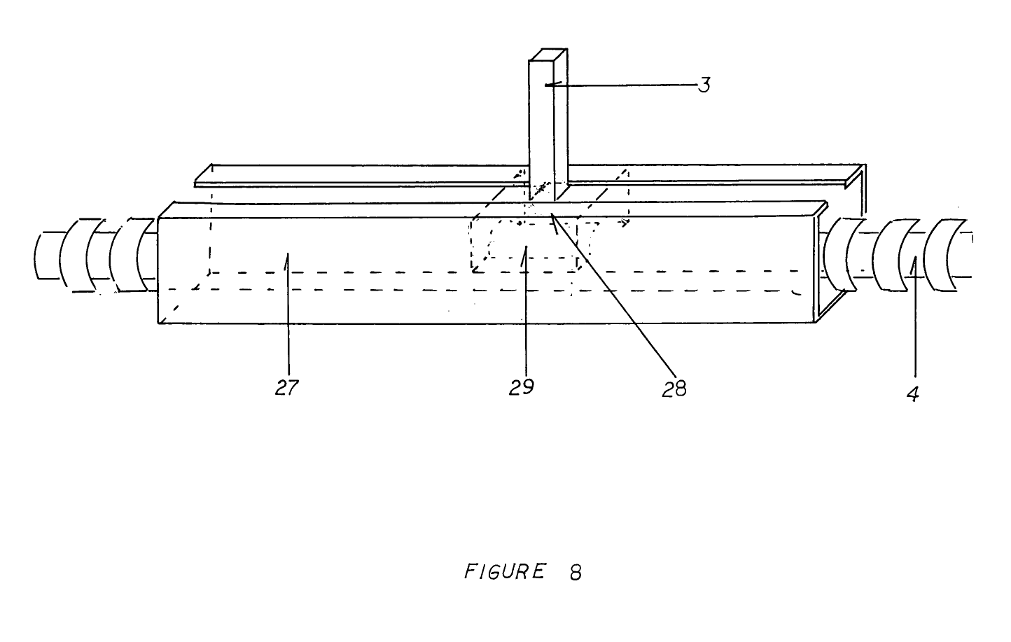

The FIG. 8 illustrates the embodiments of the push rod with base 3 and the shaft housing 27 with the shaft which has variable pitch threads 4. The push rod 3 is connected to the base 29 and protrudes underneath of the base 29. The protruding pin 28 travels in the threads of the shaft 4. The back and forth movement of the shaft 4 inside the housing 27 pushes the troughs 2 forward. The push rods 3 are turned 90 degrees sideways as they are moved back to their original position. When the push rods 3 are sideways they do not touch the trough as they move backwards.

In summary, a multipurpose growing system has been described which allows growing trough to be moved easily while simultaneously providing automated sterilization. The multipurpose system includes plant carriers, which do not require any form of growing media to support the growth of the plants. The plant carriers are reusable and easily transportable within the system by flowing water. The system consists of flow channels for translocating the plant carriers from cleaning basin to seeding area and furthermore to the troughs. The total flow conveyor systems move troughs to the entry end and from harvest end to the service area. The plant carriers allow easy removal of the plants without damaging the roots. Space between plants is automatically increased by the use of either the push rod system for the increase of space between troughs or by the use of the spacing-out-rake which slides the plants within the trough. Nutritional value of the crop is enhanced by hyperaccumulating them with minerals and vitamins.

What is claimed is:

1. A system for automated growing of plants comprising:
an elevated bed, having spaced means for supporting total flow, the elevated bed being disposed between an entry end and a harvest end:
recirculating elongated means for transporting plants, the recirculating elongated means being disposed above the elevated bed and supported thereon to move along:
push rod means for propelling the recirculating elongated means in a recirculating fashion, so that movement of the recirculating elongated means along the total flow path is in the direction from entry end to the harvest end: and
a plurality of growing troughs disposed transversely along the recirculating elongated means and spaced apart along the recirculating elongated means.

2. A system according to claim 1, wherein the growing troughs are sterilized or pasteurized by bath means.

3. A system according to claim 2, wherein the disinfecting bath means further comprises a sensor disposed within the bath means for sensing strength if disinfectant or sensing temperature of pasteurization contained therein.

4. A growing system comprising:
one or more elevated trough push rod systems for transporting troughs from an entry end to a harvest end, the elevated trough push rod systems having a feed path and a nutrient feed axis parallel to the movement of the troughs:
a plurality of elongated growing troughs having side walls for supporting plant carriers and plants, the elongated growing troughs being disposed on the elevated trough push rod system in direction transverse to the feed axis;
a supply line disposed along the feed axis on a supply side of the elevated trough push rod system for delivering nutrients and vitamins to the growing troughs, the supply line being level to facilitate the disinfecting of the supply lines;
a return line disposed parallel to the feed axis on a a return side of the elevated trough push rod system opposite the supply side, and positioned to allow the elevated trough push rod system to empty into the return line, the return line being level to allow disinfecting and sterilization;
a plurality of feed tubes for dispensing a nutrient and vitamin solution into growing troughs, the feed tubes being positioned at the same level to facilitate disinfecting ans sterilization;
reservoir containing disinfecting solution or means of pasteurization at the harvesting side, the reservoir is positioned so that growing trough is submerged into disinfecting fluid or pasteurization tank as the troughs move along towards entry end; and air conditioned tunnel for precooling and transporting the harvested plants, having a conveyor belt and removable covers. The tunnel being disposed transverse to the feed axis at the harvesting end of the elevated plant conveyor.

5. The growing system further comprising a elongated trough with elongated inwardly directed wings on the side walls.

6. The growing system comprising elongated trough with elongated ridges along bottom for facilitating an even distribution of nutrient solution and for aerating the plant roots.

7. The growing system wherein the elongated ridges along the bottom are rounded.

8. The growing system comprising different troughs for means for holding vegetables, seedlings, transplants, cuttings and containerized plants.

9. The growing system comprising growing troughs with coating, surfactant or liner providing protection from toxicity caused by chemical reactions resulting from nutrient solution contacting the troughs.

10. The growing system comprising a harvesting zone formed by one or more elevated plant conveyors in service area.

11. A growing trough comprising:
a channel member having a plurality of ridges extending along a trough to limit liquid gradients and to promote aeration of roots of the plants; and
a pair of inwardly directed wings on side walls of the trough.

12. The growing system comprising:
an interchangeable push rod with base;
a base with protruding pin, which fits into threads in the shaft;
an interchangeable shaft with variable pitch threads;
an elongated shaft housing with a pair of wings on side of the walls;
back and forth turning mechanism for the elongated shaft;
a 90 degree rotating mechanism for elongated shaft housing, for elongated shaft and push rods.

13. The growing system comprising:
a spacing-out-rake of plants in troughs;
a spacing-out-rake with elongated arms;
elongated adjustable arms with grippers at ends;
arm movement mechanism for adjustment of space between grippers;
rack and pinion or threaded rod and nut assembly for arm movement;
swivel assembly around pinions and nuts for free elongated arm and rack movement; and
common anchor base for arms.

14. The growing system comprising:
a plant carrier with absorbent or capillary action base:
a plant carrier manufactured for floating with flow of water;
a plant carrier with a support wing and a groove for gripper;
a plant carrier which allows easy removal of plants without damaging the roots; and
a plant carrier for plant support without any kind of growing media.

15. The growing system comprising:
a cleaning, disinfecting and pasteurizing basin with funnel;
funnel in the basin directs plant carriers to troughs with the flow of water;
connection between trough and basin with a seal;
funnel with outwardly wings along walls;
flowing water recirculating system for the movement of plant carriers.

16. The growing system comprising:
a nutrient system for hyperaccumulating of edible crops with minerals and vitamins.

17. The growing system comprising:
a total flow system with conveyor and push rod combined with plant carrier translocating with flow of water.
